(19) United States
(12) Patent Application Publication
(10) Pub. No.: US 2025/0094593 A1
(43) Pub. Date: Mar. 20, 2025

(54) APPARATUS, METHOD AND NON-TRANSITORY MACHINE-READABLE STORAGE MEDIUM

(71) Applicants: Ned M. SMITH, Beaverton, OR (US); Vincent R. SCARLATA, Beaverton, OR (US); James BEANEY, JR., Raleigh, NC (US)

(72) Inventors: Ned M. SMITH, Beaverton, OR (US); Vincent R. SCARLATA, Beaverton, OR (US); James BEANEY, JR., Raleigh, NC (US)

(21) Appl. No.: 18/895,533

(22) Filed: Sep. 25, 2024

Related U.S. Application Data
(60) Provisional application No. 63/648,710, filed on May 17, 2024.

(51) Int. Cl. G06F 21/57; H04L 9/32

(52) U.S. Cl. CPC G06F 21/57; H04L 9/3247

(57) ABSTRACT

It is provided an apparatus comprising interface circuitry, machine-readable instructions, and processing circuitry to execute the machine-readable instructions. The machine-readable instructions include instructions to generate an attestation evidence for verifying the integrity of a first confidential computing environment, the first confidential computing environment executing a workload. The machine-readable instructions further include instructions to obtain a collection of attestation evidence associated with the workload, the collection of attestation evidence comprising attestation evidence for verifying the integrity of each confidential computing environment that the workload was deployed to during its lifecycle. The machine-readable instructions further include instructions to generate a migration image comprising the workload, the generated attestation evidence and the collection of attestation evidence. The machine-readable instructions further include instructions to transmit the migration image to a second confidential computing environment, the second confidential computing environment going to execute the workload.

### BACKGROUND

When a workload is executed in a confidential computing environment, downtime caused by software updates, periodic maintenance, or efforts to enhance resiliency, should be avoided. Therefore, the workload may be migrated to another confidential computing environment. Throughout this migration process, the attestation validity of the workload should be retained, ensuring that security and trust are maintained across all confidential computing environment involved.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus;

FIG. 2 illustrates a flowchart of an example of a method;

FIG. 3 illustrates trusted workload migration sequence; and

FIG. 4 illustrates an attestation evidence collection architecture.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

Attested confidential computing environments (CCEs) (e.g., Intel® Trusted Domain Extensions (TDX) or SGX) may require live migration to avoid environment downtime due to a software update, periodic maintenance, resiliency, load balancing, availability, update, acceleration etc. Live migration means the attested CCE may change during the life of the workload. That is a runtime image of the workload may be transferred from one processor on the same platform to another, or another processor on a different platform, or for example from a general-purpose CPU to a special purpose processor for acceleration (e.g., GPU, IPU, etc.). To retain attestation validity of the workload during migration, the attestation evidence record of the workload includes the attestation evidence from the one or more CCEs that were already targets of migration for the workload. A remote attestation verifier (e.g., Intel® Amber) must comprehend the semantics of the performed migration that may include historical attestation evidence from the list of CCEs the workload was deployed on during its lifecycle. To ensure scalable intelligible results, the format used for regular evidence should be common with the format used for the historical evidence.

This herein disclosed technique uses industry standard attestation evidence formats (for example TCG concise evidence and conceptual message wrappers) to dynamically construct a collection of attestation evidence collection (also referred to as attestation evidence history) that shows the migration path of the workload.

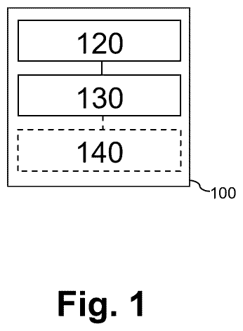

FIG. 1 illustrates a block diagram of an example of an apparatus 100 or device 100. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For ex-ample, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the ma-chine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or be-tween modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage. For example, the storage circuitry 140 may store a (UEFI) BIOS.

The processing circuitry 130 is configured to generate an attestation evidence for verifying the integrity of a first confidential computing environment. The first confidential computing environment executing a workload. Attestation evidence may be a comprehensive set of data used to verify the integrity and security of integrity of a first CCE and/or its components at a specific point in time. The attestation evidence may be used in an attestation process to provide verifiable proof to a verifier that the CCE and/or its components are secure, untampered with, and operating as expected, allowing the verifier to establish trust in the CCE's integrity and security status. In some examples generating the attestation evidence may comprise signing one or more measurements of the first CCE with a private key to produce a digital signature, ensuring the integrity and authenticity of the measurement. Attestation evidence may comprise the measurement and the cryptographic signature of the measurement.

In some examples, the first CCE and the workload are executed on a first host comprising the processing circuitry 130. In another example, the first CCE and the workload are executed on a first host which is not comprising the processing circuitry 130 and is communication with the processing circuitry 130 for example via the interface circuitry 120.

A CCE architecture may comprise a combination of specialized hardware and software components designed to protect data and computations from unauthorized access and tampering within a computer system. The CCE architecture may provide secure processing circuitry, which is responsible for executing sensitive workloads in an isolated environment. Additionally, the CCE architecture may provide secure memory, such as a protected region of the computer system's RAM, where sensitive data can be stored during computation. To further safeguard this data, the CCE architecture may provide memory encryption, ensuring that the contents of the system memory are protected even if physical access to the memory is obtained. For example, the CCE architecture may support I/O isolation and secure input/output operations, preventing data leakage during communication between the processing circuitry and peripheral devices. In some examples, the CCE architecture may provide secure storage capabilities of the computer system, such as a secure partition within the system's main storage, dedicated to storing cryptographic keys, sensitive configuration data. This secure storage ensures that critical data remains protected even when at rest. In some examples, the CCE may also comprise separate secure storage components, such as a tamper-resistant storage chip, like an integrity measurement register, to securely store measurements of the CCE and/or critical data associated with the CCE's operation. A host may generate one or more instances of CCEs based on the CCE architecture. The instances of the CCE architecture may be referred to as a CCE (also referred to as a Trusted Execution Environment). The CCE uses its components to enable the secure and isolated execution of workloads. A workload executed in the CCE may include a set of applications, tasks, or processes that are actively managed and protected by these secure hardware components. This includes computational activities that utilize the CCE's resources, including CPU, memory, and storage, to perform their operations. Such activities may involve running applications, processing sensitive data, performing calculations, and managing tasks that require a high level of security and confidentiality. The CCE ensures that these workloads are protected from unauthorized access and tampering by leveraging hardware-based security features and cryptographic measures, thereby maintaining the integrity and confidentiality of the data and processes throughout their execution

A measurement of the CCE or a part of the CCE may represent the state of a component, such as a hardware, software or firmware component involved with the CCE at a specific point in time. A measurement may be a digest, such as a cryptographic hash, that uniquely reflects the state of the CCE and/or one or more of its components at that specific point in time. A measurement of a software (including firmware) component may comprise a cryptographic hash of the software. This hash may include the binary executable code, configuration data, and/or initial state data of that software or software component. The hash is generated by reading the raw binary data of the system software components and processing it through a cryptographic hash function (e.g., SHA-256) to produce a fixed-size hash value that uniquely represents the exact state of the component at that point in time. For example, the measurement of the system software (also referred to as a claim) may comprise an image of the system software. The measurement of the system image may include a cryptographic hash of the binary executable code, configuration data, and initial state data of the system software or system software components, such as the BIOS/UEFI, bootloader, and operating system kernel.

The CCE may comprise one or more hierarchical layered environments (see FIG. 7), each specifically designed to perform distinct computing functions within the CCE. These environments may be categorized based on their roles and responsibilities, ensuring a structured and secure computing framework. An environment of the CCE may comprise one or more modules, each responsible for specific tasks or operations within that environment. A module of an environment of the CCE may be configured to execute particular functions such as initializing the environment, running applications, managing data, performing cryptographic operations, or ensuring the integrity of the environment and its processes. These modules work together within their respective environments to maintain the security, integrity, and confidentiality of the CCE as a whole. For example, there may be one or more foundational environments of the CCE responsible for core security functions, such as the Root of Trust (RoT). The RoT may be a hardware-based security component that provides a secure and immutable trust anchor for the layers above it. The foundational security provides the essential security mechanisms and trust anchors upon which the entire framework is built. The foundational security framework provides the base upon which the entire CCE's security relies. One example of a foundational security framework is the Device Identifier Composition Engine (DICE) specification. DICE is a hardware-based security mechanism that generates unique cryptographic identities and keys based on the initial measurement of a device's hardware and firmware state during boot. DICE comprises a process that derives cryptographic keys at each stage of the boot process. The keys derived based on DICE may be used to derive various cryptographic keys, including firmware keys and quoting keys, which create a chain of trust through layered identities and attestation. DICE may be defined in the specification “DICE Attestation Architecture” by the Trusted Computing Group, Version 1.1, Revision 0.18, Jan. 6, 2024. Further, the foundational environment of the CCE may comprise a trusted platform manager (also referred to as a Trusted Platform Module, or TPM). The trusted platform manager may record measurements of the CCE into an integrity register and manage cryptographic keys to sign measurements for internal verification. The trusted platform manager ensures that the system starts from a trusted state, forming the foundational security upon which the CCE operates.

Another environment within the CCE may be the quoting environment (QE), also known as the quoting agent, which is responsible for gathering, formatting, reformatting, and signing measurements and generating attestation evidence (also referred to as quotes) from other layered environments within the CCE. The QE may comprise modules responsible for handling cryptographic operations, such as formatting and signing the integrity measurements collected from higher layers. For instance, the QE may receive measurements from an execution environment and format or sign them with a cryptographic key to produce attestation evidence. This attestation evidence may be consolidated and structured in a way that can be verified by an external attestation verifier. For example, the CCE may comprise an execution environment (such as a tenant environment (TE)) and a service environment (such as a migration environment (ME)). The execution environment may be a secure, isolated execution space dedicated to running a tenant's (user's) applications, data, and workloads.

The execution environment, such as the tenant environment, is a secure, isolated execution space dedicated to running a tenant's (user's) applications, data, and workload inside the CCE. It is layered on top of the foundational hardware and firmware components of the CCE, which provide the basic secure enclave and isolated execution capabilities. This environment is designed to ensure that the tenant's assets are isolated from other tenants and protected from the underlying system, including the hypervisor and host operating system. The tenant environment may comprise one or more of the following components: A runtime environment, which includes the operating system or some OS layer that provides essential services for application execution; one or more libraries, which are precompiled code modules that offer common functionality needed by the tenant's applications; the tenant's application code, which performs specific tasks or computations; and the data processed by these applications. Further, bring-up code of the tenant environment may be used to initialize and load the one or more components of the tenant environment, taking the measurements of the tenant environment, and/or configuring the secure memory regions and execution contexts needed for their operation. In other words, the bring-up code of the tenant environment establishes and secures the tenant environment, ensuring that it is ready for safe and isolated execution within the CCE.

In some examples, generating the attestation evidence for verifying the integrity of the first CCE may comprise generating a plurality of measurements. The plurality of measurements is proving the integrity of a plurality of layered environments of the first confidential computing environment. For example, the plurality of measurements comprises a plurality of signed measurements. In other words, in some examples, the attestation evidence for verifying the integrity of the first CCE may comprise one or more measurements of the layered environments of the first CCE and the corresponding signatures of these measurements. A measurement together with its signature may be referred to as signed measurement. Signing a measurement may comprise generating a digital signature by encrypting a digest of the measurement, such as a hash, with a private key, thereby ensuring the authenticity and integrity of the measurement. For example, generating a digital signature may comprise creating a cryptographic hash of the measurement (the component's state) and then signing this hash with a private key to produce a digital signature, ensuring the integrity and authenticity of the measurement. The attestation evidence may be used in an attestation process to provide verifiable proof that the system's components are secure, untampered with, and operating as expected, allowing a verifier to establish trust in the system's integrity and security status.

In some examples, a measurement from a higher layer is signed by a lower layer to maintain a continuous chain of trust. This may be referred to as a trust dependency between the higher layer and the lower layer. For example, the measurement of a higher layer is signed with the private key of a lower layer, and the public key of the private-public key pair of the higher layer may also be signed with the private key of the lower layer. This ensures that the public key, when used to verify the measurement, is authenticated by the lower layer's signature. A private-public key pair, also known as asymmetric cryptography or public-key cryptography, is a cryptographic tool used for secure communication and authentication. The private key is kept secret and is used to sign data, creating a digital signature that verifies the data's integrity and origin. The corresponding public key is shared openly and is used to verify the digital signature created by the private key, ensuring that the data has not been tampered with and confirming the identity of the sender. This pair enables secure data exchange and authentication without needing to share the private key, thus maintaining security.

In some examples, the first (and/or the second) CCE comprise at least one of the following layered environments: A foundational environment (such as the Root of Trust (RoT)), a firmware environment, a trusted platform manager environment (which may manage the security of multiple CCEs), a quoting environment (QE), a tenant environment (TE) and a migration environment ME. In some examples, the least one of the following trust dependencies applies: A signed measurement of the tenant environment has a trusted dependency on the quoting environment; a signed measurement of the quoting environment has a trust dependency on the trusted platform environment; a signed measurement of the trusted platform has a trust dependency on the package firmware environment; and a signed measurement of the firmware environment has a trust dependency on a root of trust of a processor executing the first CCE. For example, the RoT, as the lowest layer and part of the processing circuitry 130, may receive a measurement of the firmware. The RoT signs the measurement of the firmware with its private key and also signs the public key of the firmware. Next, the firmware environment receives a measurement of the trusted platform manager environment, signs it with its private key, and also signs the public key of the trusted platform manager. It may also include the previously signed measurement from the RoT. For example, this process may continue for further subsequent layers, for example up to the QE. The QE then receives measurements from higher layers, such as the TE and ME, and signs them with its private key. The corresponding public key is verified by the lower layers. Further, it may include signatures from lower layers which are attested down to the RoT as described above. This hierarchical signing process ensures that each layer's integrity is verifiable, creating a robust chain of trust throughout the CCE.

In some examples, the attestation evidence may comprise at least one of the following: One or more measurements, the corresponding signatures of these measurements, the corresponding public keys, and the signatures of these public keys. Additionally, the attestation evidence may include configuration data, telemetry data, and/or inference data. Configuration data may comprise initial settings for the execution of the software image being measured, such as default operational states like tick counters and file descriptor states. Telemetry data may include operational metrics available to the running image, such as memory usage, CPU cycles, and power cycles, providing insights into the system's performance. Inference data may comprise operations performed by the software image that relate to the integrity of the environment, such as extending the environment with runtime images. The inference data might include a manifest structure containing a Merkle Tree of digests of the extended images.

The processing circuitry 130 is further configured to obtain a collection of attestation evidence associated with the workload, the collection of attestation evidence comprising attestation evidence for verifying the integrity of each confidential computing environment that the workload was deployed to during its lifecycle. For example, the workload was deployed to one or more CCEs before it was executed by the first CCE. For example, the workload was live migrated between CCEs to avoid environment downtime due to software update, periodic maintenance, or for resiliency. Live migration may mean that the CCE which is executing the workload is changed (the workload is migrated) during the life of the workload. The collection of attestation evidence associated with the workload may comprise one or more attestation evidence for one or more of the CCEs that the workload was deployed to during its lifecycle. For example, the collection of attestation evidence associated with the workload may comprise one or more attestation evidence for each of the one or more of the CCEs that the workload was deployed to. Each of attestation evidence of the collection of attestation evidence may be structured as attestation evidence described above and comprising one or more signed measurements based on one or more layered environments of the repetitive CCE. For example, the attestation evidence collection may have the structure of a matrix or an array, where each row or column represents a specific CCE and each element within a row or column represents a distinct piece of attestation evidence, corresponding to a layered environment of the respective CCE.

The collection of attestation evidence may be obtained from the QE of the first CCE that is currently executing the workload, which may have received it from a CCE that previously executed the workload and is now. The QE of the first CCE may manage the attestation evidence.

The processing circuitry 130 is further configured to generate a migration image. The migration image may comprise the workload, generated attestation evidence, and the collection of attestation evidence. For example, an image of the workload may be included in the migration image. The image of the workload refers to a complete, executable snapshot of the application or service that is migrated to the second CCE. This image contains all necessary code, data, and state information needed to resume operation in the target environment. In some examples, the generated attestation evidence for verifying the integrity of the first CCE is included in the collection of attestation evidence associated with the workload, and this updated collection of attestation evidence is then included in the migration image. For example, the workload (for example, an image of the workload), the generated attestation evidence, and the collection of attestation evidence may be added to a single file, which may be compressed to yield the migration image.

In some examples, the migration image may further contain configuration data, metadata and/or other context used in the process of migration. Configuration data may comprise settings and parameters necessary for the workload to operate correctly in the destination environment, such as network configurations, system preferences, and resource allocations. Metadata may comprise additional information about the migration image, such as its creation time, version, and authorship details. Other context may refer to any supplementary information that supports the migration process, such as dependencies, runtime states, and specific environmental conditions that need to be replicated or adjusted in the second CCE. Including these elements ensures a seamless transition, allowing the workload to function properly and consistently after migration

The processing circuitry 130 is further configured to transmit the migration image to a second confidential computing environment. The second confidential computing environment is going to execute the workload. That is the second CCE may load and run the application or service contained within the migration image. This may involve resuming the operation of the workload using the complete, executable image of the workload provided, along with its associated data and state information, ensuring that the application or service continues to function as intended in the second CCE.

For example, the first CCE may be executed on the first host and the second CCE may be executed on a second host. In one example, the first and the second host are the same. In another example, the first and the second host are different from each other. For example, the first and the second CCE may communicate via the interface circuitry 120. For example, the first CCE may comprise a first migration environment and the second CCE may comprise a second migration environment, which are logical separated layers in the CCEs. For example, some or all steps described above may be carried out by the first migration environment and/or by the second migration environment.

The attestation evidence collection may be verified by an (external) verifier. The verifier may verify the all the attestation evidence of the attestation evidence collection. The verifier may be an external verifier, that is external to the computing system of the processing circuitry 130. The verifier may be an entity responsible for validating the authenticity and integrity of the attestation evidence collection. This may involve checking the cryptographic signatures, measurements, configuration data, telemetry, and inference data provided in the attestation evidence collection to ensure that the software and environment have not been tampered with and are operating as expected.

The above described technique may ensure a secure live migration of workloads between two CCEs. That is a robust chain of trust is maintained. By generating attestation evidence for verifying the integrity of the first CCE and obtaining a collection of attestation evidence for all CCEs the workload has been deployed to, this method provides a comprehensive and verifiable record of the workload's security status throughout its lifecycle. The migration image, which includes the workload, generated attestation evidence, and the collection of attestation evidence, ensures that the integrity and security of the workload are preserved during transmission and execution in the second CCE.

In some examples, the attestation evidence for verifying the integrity of the first CCE and the collection of attestation evidence associated with the workload are available in a wrapper data structure. A wrapper data structure may be a container format that encapsulates and organizes various pieces of attestation evidence in a standardized and accessible manner. For example, the wrapper data structure may serve to aggregate and securely store attestation evidence of each CCE for all or some of the CCEs that the workload was applied to. This may be referred to as conceptual message wrapper.

In some examples, the wrapper data structure is a JavaScript Object Notation (JSON) array, a Concise Binary Object Representation (CBOR) array, or a CBOR tagged data structure. A JSON array is a lightweight data-interchange format that is easy for humans to read and write and easy for machines to parse and generate. CBOR is a binary data format that is designed to be small in size, fast to process, and suitable for constrained environments. A CBOR tagged data structure adds additional type information to CBOR data, allowing for more complex data representations while maintaining efficiency.

In some examples, the wrapper data structure is embedded into a secure data container. A secure data container may be a standardized format that encapsulates and protects data to ensure its integrity, authenticity, and confidentiality during transmission and storage. These containers may use cryptographic techniques to secure the enclosed data, making it verifiable and tamper-resistant. For example, the wrapper data structure may be embedded into at least one of the following: JSON Web Token (JWT), CBOR Web Token (CWT), SPDM transcript, X.509 certificate, and XML-Digital Signature document.

A web token is a compact format for representing information between two parties, typically used for authentication and authorization purposes. A web token may comprise a header, a payload, and a signature. The payload may be the attestation evidence collection. A JSON Web Token (JWT) is a specific type of web token that uses a JSON object to represent the claims, ensuring security through signature or encryption. A CBOR Web Token (CWT) is similar to a JWT but uses the CBOR format, which may be more efficient for constrained environments. An SPDM transcript is a secure communication record used in Secure Platform Device Management to ensure the integrity and authenticity of messages exchanged between devices. An X.509 certificate is a digital certificate that uses the X.509 public key infrastructure standard to verify the identity of entities and secure communications. An XML-Digital Signature document is an XML-based standard for digitally signing data, ensuring its integrity and origin.

The wrapping formats secure containers etc. may be for example also described in the document “RATS Conceptual Messages Wrapper (CMW)”, by the authors Henk Birkholz and Ned Smith and Thomas Fossati and Hannes Tschofenig, published by the Internet Engineering Task Force on Jul. 24, 2024.

As described above, each of the attestation evidence included in the attestation evidence collection may be verified by a verifier. The attestation verifier must comprehend the semantics of migration, which may include evidence collection from the list of CCEs the workload was deployed on during its lifecycle. The technique described above ensures scalable and intelligible results. The wrapper data structure ensures that all the evidence is encapsulated in a standardized and structured format. This wrapper data structure maintains a consistent and verifiable record of the workload's deployment history across various CCEs. This approach facilitates efficient transmission, verification, and processing of the attestation evidence, ensuring the integrity and authenticity of the data throughout the workload's lifecycle.

In some examples, the processing circuitry 130 may be further configured to transmit the migration image to the second confidential computing environment only if a migration policy corresponding to the workload is satisfied. In some examples, the load and/or execution of the workload in the second CCE may be only performed if a migration policy corresponding to the workload is satisfied. A migration policy may be set of predefined criteria and conditions tailored to the specific requirements of a workload that must be met for its migration from one CCE to another. The migration policy ensures the security and integrity of the workload throughout its lifecycle. The migration policy may comprise the required security level of a destination CCE. The policy may also include conditions regarding the configuration and operational state of a destination CCE to ensure compatibility and security. By tailoring the migration policy to correspond to the specific workload, the policy addresses the unique security and operational needs of that workload. This ensures that workloads are only transferred to environments with adequate security protections, thus preserving the overall security posture and trustworthiness of the system.

In some examples, the processing circuitry 130 may be further configured to transmit the migration image to the second confidential computing environment only if a security level of the second confidential computing environment as is exceeding a threshold as defined in a migration policy corresponding to the workload. In some examples, the security level of the destination CCE must meet or exceed a specified threshold relative to the originating CCE.

The security level of a CCE may be a measure of its capability to protect the integrity, confidentiality, and availability of the workloads it hosts. This level may be determined by evaluating a range of factors including hardware integrity and secure boot processes; firmware security, such as the implementation of secure firmware updates and vulnerability protections; software robustness, including the use of secure coding practices and regular security audits; and the strength of implemented security measures, such as encryption, access controls, and intrusion detection systems. The security level may be determined by analyzing the attestation evidence of CCE and/or its parts, which provide verified information about the state and integrity of the hardware, firmware, software, and security measures implemented within the environment. In some examples, the security level of the second CCE may be provided by the second CCE to the first CCE.

In some examples, the second CCE generates attestation evidence comprising the attestation evidence of its environment, including details about hardware integrity, firmware versions, software states, and implemented security measures. This attestation evidence may be transmitted to the first CCE. Upon receiving the evidence, the first CCE analysis the attestation evidence from the second CCE with its own attestation evidence to determine the security level of the second CCE. Only if the security level of the second CCE is exceeding the threshold as defined in the migration policy the migration image be generated and transmitted to the second CCE. In other words, only if the security levels are deemed sufficiently logical equivalent, the migration is permitted to proceed, ensuring that the workload remains secure, and the integrity of the computing environment is maintained.

In some examples, if the workload has been migrated to the first CCE from one or more previous CCEs, the migration policy of the workload may further demand to be satisfied if the security level of the destination CCE meets or exceeds a specified threshold relative to each of the security levels of the previous CCEs.

This enforcement of the migration authority be done by the first CCE or by the second CEE or by a third entity.

In some examples, the processing circuitry 130 is further configured to obtain a signature key and/or an encryption key for the migration image. In some examples, the processing circuitry 130 is further configured to sign, encrypt, or sign and encrypt the migration image with the signature key and/or encryption key. For example, the encryption key is a public key of a private-public key pair. For example, the encryption key is received from the second CCE. In some examples, the migration image is encrypted with the encryption key and then transmitted to the second CCE. The second CCE may then decrypt the encrypted migration image with the corresponding private key of corresponding private-public key pair.

In another example, the migration image may be encrypted with a symmetric key, generated by the first CCC. This symmetric key may be encrypted with the encryption key, for example, a public key from the second CCE. The encrypted migration image and the encrypted symmetric key may then be transmitted to the second CCE. The second CCE may decrypt the encrypted symmetric key with its private key of the corresponding private-public key pair and the decrypt the migration image with the decrypted symmetric key.

In some examples, additionally or instead, the first CCE may obtain a signature key. For example, the first CCE may generate the signature key. For example, the signature key may be a private key of a private-public key pair. For example, the first CCE may be sign the migration image with the signature key and transmit the public key together with the migration image and a signature of the migration image to the second CCE. The second CCE may then authenticate the migration image by verifying the signature of the migration image. In some examples, CEE isolation primitives (e.g., Intel TDX/SGX) may be used to protect signing keys.

In some examples, the processing circuitry 130 is further configured to convert the workload to be executable by a processor architecture running the second CCE. The conversion of the workload may comprise translating the binary code of the workload to be compatible with the processor architecture of the host executing the second CCE. For example, the first host processor architecture may comprise a general-purpose CPU, and the second host processor architecture may comprise a specialized processor like a GPU or IPU, or vice versa. Further, the conversion of the workload may comprise workload decomposition using Function-as-a-Service (FaaS). FaaS refers to a cloud computing service that allows developers to execute code in response to events without managing server infrastructure, thus enabling scalable and flexible deployment of functions as discrete units of work. Additionally, the conversion of the workload may involve incorporating workload metadata that supports multi-environment execution, ensuring that the workload can operate seamlessly across different processor architectures and environments. This conversion of the workload ensures that it maintains its functionality and performance characteristics despite differences in the underlying processor architecture of the first CCE and the second CCE, enabling seamless and efficient migration across diverse computing environments.

Upon receiving the migration image from the first CCE, the second CCC may decrypt and/or authenticate the migration image as described above. The (decrypted) migration image contains the workload, necessary configuration data, metadata, and other context required for the migration. The second CCE may then install the workload, for example into a tenant environment of the second CCE. This process ensures that the workload is correctly configured and ready to execute in the new environment, taking into account the specific hardware and software requirements of the second CCE. The installation process may also include converting the workload to be compatible with the processor architecture of the second CCE as described above.

After the installation of the workload, the second CCE, for example a quoting environment or a migration environment of the second CCE, may generate attestation evidence to verify the integrity and security of the second CCE with the newly installed workload. This attestation evidence may comprise measurements of one or more layered environments of the second CCE as described above. The second CCE may the update the attestation evidence collection of the workload received from the first CCE by adding this newly generated attestation evidence, ensuring a comprehensive and up-to-date record of the workload's deployment history. This updated evidence collection is use for maintaining trust and verifying the integrity of the workload throughout its lifecycle, facilitating secure and reliable migration across different CCEs.

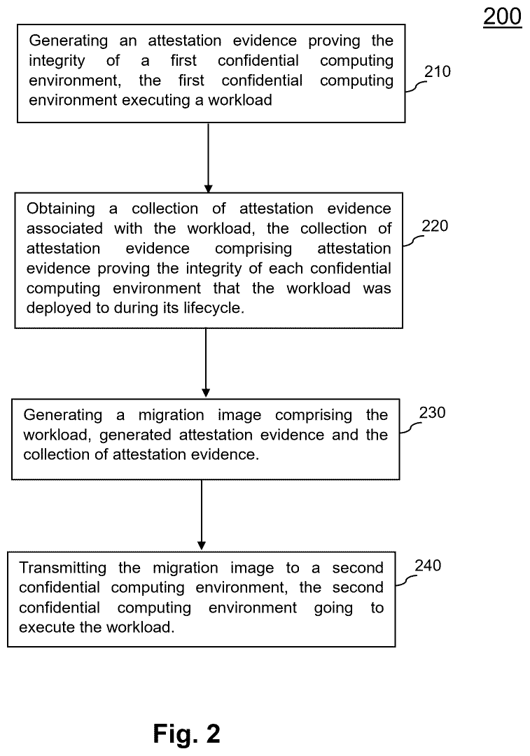

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-4).

FIG. 2 illustrates a flowchart of an example of a method 200. The method 200 may, for instance, be performed by an apparatus as described herein, such as apparatus 100. The method 200 comprises generating 210 an attestation evidence for verifying the integrity of a first confidential computing environment, the first confidential computing environment executing a workload. The method 200 further comprises obtaining 220 a collection of attestation evidence associated with the workload, the collection of attestation evidence comprising attestation evidence for verifying the integrity of each confidential computing environment that the workload was deployed to during its lifecycle. The method 200 further comprises generating 230 a migration image comprising the workload, generated attestation evidence and the collection of attestation evidence. The method 200 further comprises transmitting 240 the migration image to a second confidential computing environment, the second confidential computing environment going to execute the workload

More details and aspects of the method 200 are explained in connection with the proposed technique or one or more examples described above, e.g., with reference to FIG. 1. The method 200 may comprise one or more additional optional features corresponding to one or more aspects of the proposed technique, or one or more examples described above.

### Further Examples

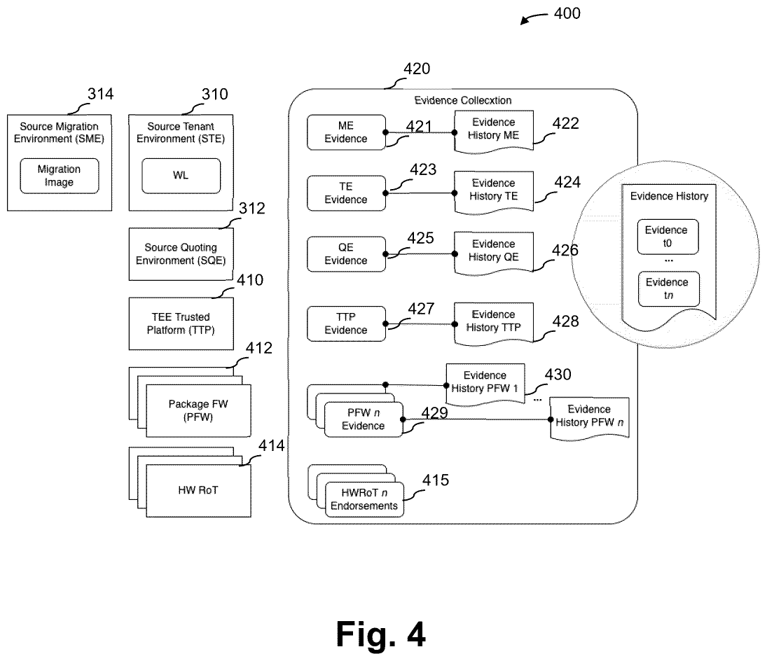

For example, the migration may be carried out by one or more migration services of the CCE. The one or more migration services may build, transfer, and install the migration image. For example, the migration service may be implemented as a layered environment within the CCE, such as the Migration TD (MTD) in Intel® TDX. For example, a tenant environment (e.g., tenant TD (TTD) in Intel® TDX) may have a configured MTD. Cross-platform or cross-architecture migrations may use a first migration environment (also referred to as source migration environment (SME)) of the first CCE (also referred to as the source CCE) and a second migration environment (also referred to as destination migration environment (DME)) of the second CCE (also referred to as destination CCE). The first migration environment may build the migration image, identify and qualify a target environment, obtain a migration key, build the migration image, and/or convey the image to the second migration environment. The second migration environment may decrypt the migration image, load the workload, and/or attest the recently migrated image invoking the services of the second quoting environment (also referred to as target quoting environment) of the second CCE. The second migration environment may store the migration history for later inspection (e.g., via a migration history service, local storage, NAS, or DLT). When migrating a tenant workload, the migration image may contain an evidence collection as described above and in FIG. 4 The migration image may also contain the workload to be migrated and configuration, metadata, and/or other context used to negotiate the migration. The DME may accept the handoff of the migration image from the SME.

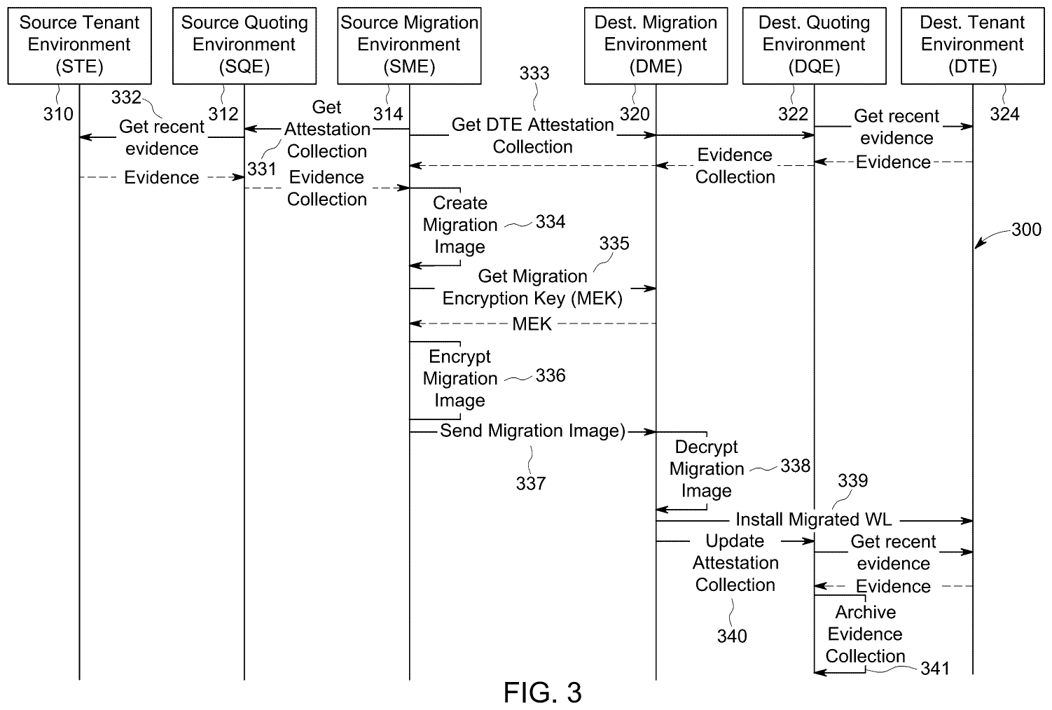

FIG. 3 illustrates trusted workload migration sequence 300. A first CCE may comprise a source tenant environment (STE) 310 the executes the workload to be migrated, a source quoting environment (SQE) 312 that generates and collects attestation evidence and a source migration environment (SME) 314 that performs the workload migration on the side of the first CCE. A second CCE may comprise a destination tenant environment (DTE) 320 the executes the migrated workload, a destination quoting environment (DQE) 322 that generates and collects attestation evidence and a destination migration environment (DME) 324 that performs the workload migration on the side of the second CCE.

In step 331 the SME 314 asks the SQE 312 to obtain the stored attestation evidence collection. In step 332 the SME 314 asks the SQE 312 to obtain a recent attestation evidence (signed measurement), which is attesting the currently running workload, from the STE 310 and add it to the obtained attestation evidence collection. The SME determines the trustworthiness properties of the current workload.

In step 333 the SME 314 attests the second CCE that is a candidate for migration by asking the DME 320 to transmit an attestation evidence collection of the second CCE. The DME 320 in this regard asks the DQE 322 to obtain an attestation evidence collection which includes a recent attestation evidence from the DTE 324. Then the SME 314 determines the trustworthiness suitability of the second CCE for receiving the workload based on the received attestation evidence collection and may be on a migration policy of the workload.

In step 334 the SME 314 constructs the migration image containing the current workload, attestation evidence of the current environment, migration history. The SME 314 identifies the DTE 324 it is to be loaded into. If the host of the second CCE has a dissimilar architecture (e.g., GPU vs. CPU) the SME 314 converts the workload to the target architecture (such as via binary translation, workload decomposition using FaaS, or using workload metadata that includes multi-environment support).

In step 335 the STE 314 obtains a migration encryption key (MEK) from the DME 320. In step 336 the STE 314 encrypts the migration image. In In step 337 the STE 310 transmits the encrypted migration image to the DME 320 for further processing. In step 337 the DME 320 decrypts the encrypted migration image using a decryption key (for example the private key of the MEK). In step 339 the DME 320 installs the migration image into the DTE 324. In step 340 DME 320 request from the DQ § 322 to update the attestation evidence collection, that is to include a recently generated attestation evidence (for example including dependent layered environments of the second CCE, such as DICE layering) of the installed workload. The DQE 322 adds the recent attestation evidence to the collection. In step 341 the DQE 322 archives the attestation evidence collection for future use. For example, the various message exchanges as described above 3 are authenticated and reply protected.

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIG. 4).

FIG. 4 illustrates an attestation evidence collection architecture 400. The attestation evidence collection architecture 400 shows the attestation evidence collection based on a the first CCE comprising the following layer environments: A first CCE may comprise a STE 310, the SQE 312 the SME 314. The STM 310 has a trust dependency on the SQE 312. SME 314 may also have trust dependency on the SQE 312. The STE 310 relies on the SME 314 for migration services. The SQE 312 has a trust dependency on a trusted platform manager 410 (such as a TEE Trusted Platform (TTP)). The trusted platform manager 410 has a trust dependency on one or more Package firmware (PFW) components. The on one or more Package firmware (PFW) components have a trust dependency on one or more hardware root if trusts (HWRoTs) 414. One or more hardware roots of trust (RoTs) 414 exist in the processing circuitry (for example a CPU, GPU, XPU, or IPU). The one or more RoTs 414 each have associated endorsement 415 manifests or certificates that describe the security properties of the RoT.

Each of the layered environments 310, 312, 410, 412, 414 of the first CCE can be attested to produce attestation evidence instances 421, 423, 425, 427, 429 (or associated endorsement manifests/certificates 415 in case of the RoTs). Each of the generated attestation evidence instances 421, 423, 425, 427, 429 is added to a respective attestation evidence collection 422, 424, 426, 428, 430. Each of the layered environments layered environments 310, 312, 410, 412, 414 in the layering may have a history of attestation evidence instances associated that describes the ways in which the respective layered environment has been modified over time. The evidence collection 420 therefore may comprise all the attestation evidence collections 422, 424, 426, 428, 430 of the layered environments of the CCE. The evidence collection 420 therefore may be a multi-dimensional array of current and historical attestation evidence that is related by trust dependencies as described above. The attestation evidence collection structure may be constructed using industry standards such as described in the document “RATS Conceptual Messages Wrapper (CMW)”, by the authors Henk Birkholz and Ned Smith and Thomas Fossati and Hannes Tschofenig, published by the Internet Engineering Task Force on Jul. 24, 2024.

Further details and aspects are mentioned in connection with the examples described above. The example shown in FIG. 4 may include one or more optional additional features corresponding to one or more aspects mentioned in connection with the proposed concept or one or more examples described above (e.g., FIGS. 1-3).

In the following, some examples of the proposed concept are presented:

An example (e.g., example 1) relates to an apparatus comprising interface circuitry, machine-readable instructions and processing circuitry to execute the machine-readable instructions to generate an attestation evidence for verifying the integrity of a first confidential computing environment, the first confidential computing environment executing a workload, obtain a collection of attestation evidence associated with the workload, the collection of attestation evidence comprising attestation evidence for verifying the integrity of each confidential computing environment that the workload was deployed to during its lifecycle. generate a migration image comprising the workload, the generated attestation evidence and the collection of attestation evidence, transmit the migration image to a second confidential computing environment, the second confidential computing environment going to execute the workload.

Another example (e.g., example 2) relates to a previous example (e.g., example 1) or to any other example, further comprising that the processing circuitry is further to execute the machine-readable instructions to transmit the migration image to the second confidential computing environment only if a migration policy corresponding to the workload is satisfied.

Another example (e.g., example 3) relates to a previous example (e.g., one of the examples 1 or 2) or to any other example, further comprising that the processing circuitry is further to execute the machine-readable instructions to transmit the migration image to the second confidential computing environment only if a security level of the second confidential computing environment as is exceeding a threshold as defined in a migration policy corresponding to the workload.

Another example (e.g., example 4) relates to a previous example (e.g., one of the examples 1 to 3) or to any other example, further comprising that the attestation evidence for verifying the integrity of the first confidential computing environment and the collection of attestation evidence associated with the workload are available in a wrapper data structure.

Another example (e.g., example 5) relates to a previous example (e.g., example 4) or to any other example, further comprising that the wrapper data structure is a JavaScript Object Notation (JSON) array, a Concise Binary Object Representation, CBOR, array, or a CBOR tagged data structure.

Another example (e.g., example 6) relates to a previous example (e.g., one of the examples 4 or 5) or to any other example, further comprising that the wrapper data structure is embedded into a secure data container.

Another example (e.g., example 7) relates to a previous example (e.g., example 6) or to any other example, further comprising that secure data container is at least one of the following JSON Web Token (JWT), CBOR Web Token (CWT), SPDM transcript, X.509 certificate, and XML-Digital Signature document.

Another example (e.g., example 8) relates to a previous example (e.g., one of the examples 1 to 7) or to any other example, further comprising that the generating of the attestation evidence for verifying the integrity of the first confidential computing environment comprises generating a plurality of measurements, wherein the plurality of measurements is proving the integrity of a plurality of layered environments of the first confidential computing environment.

Another example (e.g., example 9) relates to a previous example (e.g., example 8) or to any other example, further comprising that first confidential computing environment comprise at least one of the following layered environments a root of trust, a firmware environment, a trusted platform manager environment, a quoting environment, a tenant environment and a migration environment.

Another example (e.g., example 10) relates to a previous example (e.g., example 9) or to any other example, further comprising that at least one of the following trust dependencies applies a signed measurement of the tenant environment has a trusted dependency on the quoting environment, a signed measurement of the quoting environment has a trust dependency on the trusted platform environment, a signed measurement of the trusted platform has a trust dependency on the package firmware environment, and a signed measurement of the firmware environment has a trust dependency on the root of trust of a processor executing the first confidential computing environment.

Another example (e.g., example 11) relates to a previous example (e.g., one of the examples 1 to 10) or to any other example, further comprising that the migration image further comprises configuration data and/or meta data.

Another example (e.g., example 12) relates to a previous example (e.g., one of the examples 1 to 11) or to any other example, further comprising that the processing circuitry is further to execute the machine-readable instructions to obtain a signature key and/or an encryption key for the migration image.

Another example (e.g., example 13) relates to a previous example (e.g., example 12) or to any other example, further comprising that the processing circuitry is further to execute the machine-readable instructions to sign, encrypt, or sign and encrypt the migration image with the obtained signature key and/or encryption key.

Another example (e.g., example 14) relates to a previous example (e.g., one of the examples 1 to 13) or to any other example, further comprising that the processing circuitry is further to execute the machine-readable instructions to convert the workload to be executable by a processor architecture running the second confidential computing environment.

Another example (e.g., example 15) relates to a previous example (e.g., one of the examples 1 to 14) or to any other example, further comprising that the generating the attestation evidence for verifying the integrity of a first confidential computing environment comprises signing one or more measurements of the first confidential computing environment.

An example (e.g., example 16) relates to a method comprising generating an attestation evidence for verifying the integrity of a first confidential computing environment, the first confidential computing environment executing a workload, obtaining a collection of attestation evidence associated with the workload, the collection of attestation evidence comprising attestation evidence for verifying the integrity of each confidential computing environment that the workload was deployed to during its lifecycle. generating a migration image comprising the workload, generated attestation evidence and the collection of attestation evidence, transmitting the migration image to a second confidential computing environment, the second confidential computing environment going to execute the workload.

Another example (e.g., example 17) relates to a previous example (e.g., example 16) or to any other example, further comprising transmitting the migration image to the second confidential computing environment only if a migration policy corresponding to the workload is satisfied.

Another example (e.g., example 18) relates to a previous example (e.g., one of the examples 16 or 17) or to any other example, further comprising transmitting the migration image to the second confidential computing environment only if a security level of the second confidential computing environment as is exceeding a threshold as defined in a migration policy corresponding to the workload.

Another example (e.g., example 19) relates to a previous example (e.g., one of the examples 16 to 18) or to any other example, further comprising that the attestation evidence for verifying the integrity of the first confidential computing environment and the collection of attestation evidence associated with the workload are available in a wrapper data structure.

Another example (e.g., example 20) relates to a previous example (e.g., example 19) or to any other example, further comprising that the wrapper data structure is a JavaScript Object Notation (JSON) array, a Concise Binary Object Representation, CBOR, array, or a CBOR tagged data structure.

Another example (e.g., example 21) relates to a previous example (e.g., one of the examples 19 or 20) or to any other example, further comprising that the wrapper data structure is embedded into a secure data container.

Another example (e.g., example 22) relates to a previous example (e.g., example 21) or to any other example, further comprising that secure data container is at least one of the following JSON Web Token (JWT), CBOR Web Token (CWT), SPDM transcript, X.509 certificate, and XML-Digital Signature document.

Another example (e.g., example 23) relates to a previous example (e.g., one of the examples 16 to 22) or to any other example, further comprising that the generating of the attestation evidence for verifying the integrity of the first confidential computing environment comprises generating a plurality of measurements, wherein the plurality of measurements is proving the integrity of a plurality of layered environments of the first confidential computing environment.

Another example (e.g., example 24) relates to a previous example (e.g., example 23) or to any other example, further comprising that first confidential computing environment comprise at least one of the following layered environments a root of trust, a firmware environment, a trusted platform manager environment, a quoting environment, a tenant environment and a migration environment.

Another example (e.g., example 25) relates to a previous example (e.g., example 24) or to any other example, further comprising that at least one of the following trust dependencies applies a signed measurement of the tenant environment has a trusted dependency on the quoting environment, a signed measurement of the quoting environment has a trust dependency on the trusted platform environment, a signed measurement of the trusted platform has a trust dependency on the package firmware environment, and a signed measurement of the firmware environment has a trust dependency on the root of trust of a processor executing the first confidential computing environment.

Another example (e.g., example 26) relates to a previous example (e.g., one of the examples 16 to 25) or to any other example, further comprising that the migration image further comprises configuration data and/or meta data.

Another example (e.g., example 27) relates to a previous example (e.g., one of the examples 16 to 26) or to any other example, further comprising that further comprising obtaining a signature key and/or an encryption key for the migration image.

Another example (e.g., example 28) relates to a previous example (e.g., example 27) or to any other example, further comprising signing, encrypting, or signing and encrypting the migration image with the obtained signature key and/or encryption key.

Another example (e.g., example 29) relates to a previous example (e.g., one of the examples 16 to 28) or to any other example, further comprising converting the workload to be executable by a processor architecture running the second confidential computing environment.

Another example (e.g., example 30) relates to a previous example (e.g., one of the examples 15 to 29) or to any other example, further comprising that the generating the attestation evidence for verifying the integrity of a first confidential computing environment comprises signing one or more measurements of the first confidential computing environment.

An example (e.g., example 31) relates to an apparatus comprising processor circuitry configured to generate an attestation evidence for verifying the integrity of a first confidential computing environment, the first confidential computing environment executing a workload, obtain a collection of attestation evidence associated with the workload, the collection of attestation evidence comprising attestation evidence for verifying the integrity of each confidential computing environment that the workload was deployed to during its lifecycle. generate a migration image comprising the workload, generated attestation evidence and the collection of attestation evidence, transmit the migration image to a second confidential computing environment, the second confidential computing environment going to execute the workload.

An example (e.g., example 32) relates to a device comprising means for processing for generating an attestation evidence for verifying the integrity of a first confidential computing environment, the first confidential computing environment executing a workload, obtaining a collection of attestation evidence associated with the workload, the collection of attestation evidence comprising attestation evidence for verifying the integrity of each confidential computing environment that the workload was deployed to during its lifecycle. generating a migration image comprising the workload, generated attestation evidence and the collection of attestation evidence, transmitting the migration image to a second confidential computing environment, the second confidential computing environment going to execute the workload.

Another example (e.g., example 32) relates to a non-transitory machine-readable storage medium including program code, when executed, to cause a machine to perform the method of any one of examples 16 to 30.

Another example (e.g., example 33) relates to a computer program having a program code for performing the method of any one of examples 16 to 30 when the computer program is executed on a computer, a processor, or a programmable hardware component.

Another example (e.g., example 34) relates to a machine-readable storage including machine readable instructions, when executed, to implement a method or realize an apparatus as claimed in any pending example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions and processing circuitry to execute the machine-readable instructions to:
generate an attestation evidence for verifying the integrity of a first confidential computing environment, the first confidential computing environment executing a workload;
obtain a collection of attestation evidence associated with the workload, the collection of attestation evidence comprising attestation evidence for verifying the integrity of each confidential computing environment that the workload was deployed to during its lifecycle.
generate a migration image comprising the workload, the generated attestation evidence and the collection of attestation evidence;
transmit the migration image to a second confidential computing environment, the second confidential computing environment going to execute the workload.

2. The apparatus of claim 1, wherein the processing circuitry is further to execute the machine-readable instructions to transmit the migration image to the second confidential computing environment only if a migration policy corresponding to the workload is satisfied.

3. The apparatus of claim 1, wherein the processing circuitry is further to execute the machine-readable instructions to transmit the migration image to the second confidential computing environment only if a security level of the second confidential computing environment as is exceeding a threshold as defined in a migration policy corresponding to the workload.

4. The apparatus of claim 1, wherein the attestation evidence for verifying the integrity of the first confidential computing environment and the collection of attestation evidence associated with the workload are available in a wrapper data structure.

5. The apparatus of claim 4, wherein the wrapper data structure is a JavaScript Object Notation (JSON) array, a Concise Binary Object Representation, CBOR, array, or a CBOR tagged data structure.

6. The apparatus of claim 4, wherein the wrapper data structure is embedded into a secure data container.

7. The apparatus of claim 6, wherein secure data container is at least one of the following: JSON Web Token (JWT), CBOR Web Token (CWT), SPDM transcript, X.509 certificate, and XML-Digital Signature document.

8. The apparatus of claim 1, wherein the generating of the attestation evidence for verifying the integrity of the first confidential computing environment comprises generating a plurality of measurements, wherein the plurality of measurements is proving the integrity of a plurality of layered environments of the first confidential computing environment.

9. The apparatus of claim 8, wherein first confidential computing environment comprise at least one of the following layered environments: a root of trust, a firmware environment, a trusted platform manager environment, a quoting environment, a tenant environment and a migration environment.

10. The apparatus of claim 9, wherein at least one of the following trust dependencies applies: a signed measurement of the tenant environment has a trusted dependency on the quoting environment, a signed measurement of the quoting environment has a trust dependency on the trusted platform environment, a signed measurement of the trusted platform has a trust dependency on the package firmware environment, and a signed measurement of the firmware environment has a trust dependency on the root of trust of a processor executing the first confidential computing environment.

11. The apparatus of claim 1, wherein the migration image further comprises configuration data and/or meta data.

12. The apparatus of claim 1, wherein the processing circuitry is further to execute the machine-readable instructions to obtain a signature key and/or an encryption key for the migration image.

13. The apparatus of claim 12, wherein the processing circuitry is further to execute the machine-readable instructions to sign, encrypt, or sign and encrypt the migration image with the obtained signature key and/or encryption key.

14. The apparatus of claim 1, wherein the processing circuitry is further to execute the machine-readable instructions to convert the workload to be executable by a processor architecture running the second confidential computing environment.

15. The apparatus of claim 1, wherein the generating the attestation evidence for verifying the integrity of a first confidential computing environment comprises signing one or more measurements of the first confidential computing environment.

16. A method comprising:
generating an attestation evidence for verifying the integrity of a first confidential computing environment, the first confidential computing environment executing a workload;
obtaining a collection of attestation evidence associated with the workload, the collection of attestation evidence comprising attestation evidence for verifying the integrity of each confidential computing environment that the workload was deployed to during its lifecycle.
generating a migration image comprising the workload, generated attestation evidence and the collection of attestation evidence;
transmitting the migration image to a second confidential computing environment, the second confidential computing environment going to execute the workload.

17. The method of claim 16, further comprising transmitting the migration image to the second confidential computing environment only if a migration policy corresponding to the workload is satisfied.

18. The method of claim 16, further comprising transmitting the migration image to the second confidential computing environment only if a security level of the second confidential computing environment as is exceeding a threshold as defined in a migration policy corresponding to the workload.

19. The method of claim 16, wherein the attestation evidence for verifying the integrity of the first confidential computing environment and the collection of attestation evidence associated with the workload are available in a wrapper data structure.

20. A non-transitory machine-readable storage medium including program code, when executed, to cause a machine to perform the method of claim 16.
